(19) United States
(12) Patent Application Publication
(10) Pub. No.: US 2026/0140684 A1
(43) Pub. Date: May 21, 2026

(54) DEVICES, SYSTEMS, AND METHODS FOR DISPLAY SEGMENTATION AND STREAMING

(71) Applicant: University of Pittsburgh-Of the Commonwealth System of Higher Education, Pittsburgh, PA (US)

(72) Inventors: Griffin James Hurt, Bridgeville, PA (US); Jacob Biehl, Pittsburgh, PA (US); Talha Khan, Grand Rapids, MI (US); Edward Gregory Andrews, Pittsburgh, PA (US)

(21) Appl. No.: 19/395,805

(22) Filed: Nov. 20, 2025

Related U.S. Application Data
(60) Provisional application No. 63/723,393, filed on Nov. 21, 2024.

(51) Int. Cl. G06F 3/14

(52) U.S. Cl. CPC G06F 3/1423

(57) ABSTRACT

A method of providing information to a user via a local display system, wherein the local display system includes a local display, includes providing an interface via which the user may select at least one segment of a screen display from at least one of one or more information display systems for display on the local display, and displaying the at least one segment on the local display. The local display system may, for example, include the local display and electronic circuitry in communicative connection with the local display.

### CROSS-REFERENCE TO RELATED APPLICATION

This application claims benefit of U.S. Provisional Patent Application Ser. No. 63/723,393, filed Nov. 21, 2024, the disclosure of which is incorporated herein by reference.

### BACKGROUND

The following information is provided to assist the reader in understanding technologies disclosed below and the environment in which such technologies may typically be used. The terms used herein are not intended to be limited to any particular narrow interpretation unless clearly stated otherwise in this document. References set forth herein may facilitate understanding of the technologies or the background thereof. The disclosure of all references cited herein are incorporated by reference.

Numerous work environments are intensely information-driven environments. Moreover, the information complexity of many such environments is increasing. In support of task performance in such environments, the work spaces are typically rich with information displays, such as shared large displays, monitors, or screens and personal, multi-display workstations and portable tablets. The physical design of these spaces, particularly the location of the displays, cannot be easily customized or configured, as they are often limited by the task and domain of work.

Individuals working in an information-display-rich environment, are typically forced to split their attention between a task at hand and the information related to the task that is present on one or more displays (which may, for example, be affixed to walls and other physical structures). A high volume of shared information can raise cognitive load, causing workers to lose sight of important data. Moreover, limitations of most complex information environments restricts the placement and interactive capabilities of displays, thereby limiting the users'ability to simultaneously focus on the display(s) and the task site simultaneously. The resultant split in attention negatively impacts task performance and hinders learning.

It is thus very desirable to develop technologies that facilitate task performance in environments in which complex information must be conveyed to an individual during performance a task.

### SUMMARY

A method of providing information to a user via a local display system, wherein the local display system includes a local display, includes providing an interface via which the user may select at least one segment of a screen display from at least one of one or more information display systems for display on the local display, and displaying the at least one segment on the local display. The local display system may, for example, include the local display and electronic circuitry in communicative connection with the local display. The electronic circuitry may include a processor system and a memory system in communication with the processor system. In a number of embodiments, the method further includes providing software stored in the memory system of the local display system, wherein the software is executable by the processor system to provide the interface.

In a number of embodiments, the method may further include providing a streaming interface. The streaming interface may be placed in communicative connection with the local display system and with the one or more information display systems. The streaming interface may be configured to stream screen display data of the one or more information display systems to the local display system. The software may further be executable by the processor system to segment the screen display data to display the at least one segment on the local display.

The local display system may, for example, be selected from a mixed reality headset and a personal communication device. The personal communication device may, for example, be a tablet computer. In a number of embodiments, the local display system is a mixed reality headset.

The streaming interface in a number of embodiments includes a streaming server. The streaming server may, for example, include a web-based software application and the software may be a web-based client software application. The streaming software may alternatively include at least one of a computer application and a hardware device. In a number of embodiments, the streaming interface further includes a signaling server which is configured to manage connections between the local display system and the streaming server. The streaming interface may, for example, be configured to stream screen display data obtained from at least one of (i) a camera in optical connection with a display of one of the one or more information display systems and (ii) a capture of the screen display data of the one or more information display systems.

In a number of embodiments, at least one segment of a screen display from a plurality of the one or more information display systems is displayed on the local display. In a number of embodiments, a plurality of segments of the screen display from the at least one of the one or more information display systems is displayed on the local display. In a number of embodiments, the user may control at least one of the size and position of the at least one segment on the local display.

A system for providing information to a user includes a local display system, the local display system including a local display, and an interface via which the user may select at least one segment of a screen display from at least one of one or more information display systems for display on the local display. As described above, the local display system may include electronic circuitry in communicative connection with the local display. The electronic circuitry may include a processor system and a memory system in communication with the processor system. The memory system may have software stored therein which is executable by the processor system to (i) provide the interface and (ii) display the at least one segment on the local display.

In a number of embodiments, the system further includes a streaming interface. The streaming interface may be in communicative connection with the local display system and with the one or more information display systems. In a number of embodiments, the streaming interface is configured to stream screen display data of the one or more information display systems to the local display system. The software may be further executable by the processor system to segment the screen display data to display the at least one segment on the local display.

The local display system may, for example, be selected from a mixed reality headset and a personal communication device. The personal communication device may, for example, be a tablet computer. In a number of embodiments, the local display system is a mixed reality headset.

The streaming interface in a number of embodiments includes a streaming server. The streaming server may, for example, include a web-based software application and the software may be a web-based client software application. As described above, the streaming software may alternatively include at least one of a computer application and a hardware device. In a number of embodiments, the streaming interface further includes a signaling server which is configured to manage connections between the local display system and the streaming server. The streaming interface may, for example, be configured to stream screen display data obtained from at least one of (i) a camera in optical connection with a display of one of the one or more information display systems and (ii) a capture of the screen display data of the one or more information display systems.

In a number of embodiments, at least one segment of a screen display from a plurality of the one or more information display systems is displayed on the local display. In a number of embodiments, a plurality of segments of the screen display from the at least one of the one or more information display systems is displayed on the local display. In a number of embodiments, the user may control at least one of the size and position of the at least one segment on the local display.

A local display system for providing information to a user includes a local display and electronic circuitry in communicative connection with the local display. The electronic circuitry includes a processor system and a memory system in communication with the processor system. The memory system has software stored therein which is executable by the processor system to provide an interface via which the user may select at least one segment of a screen display from at least one of one or more information display systems for display on the local display and to display the at least one segment on the local display.

The present devices, systems, and methods, along with the attributes and attendant advantages thereof, will best be appreciated and understood in view of the following detailed description taken in conjunction with the accompanying drawings.

### BRIEF DESCRIPTION OF THE DRAWINGS

FIG. 1A illustrates an embodiment of a system hereof in which a surgeon is viewing user-selected segments of the displays of a number of information display systems via a holographic or mixed reality display generated by a mixed reality headset.

FIG. 1B illustrates an embodiment of a mixed reality headset for use herein.

FIG. 1C illustrates another embodiment of a mixed reality headset for use herein.

FIG. 1D illustrates an embodiment of a tablet computer for use herein.

FIG. 2 illustrates an embodiment of interaction with a modality client hereof with an embodiment of a streaming interface system hereof.

FIG. 3A illustrates a screen shot photograph of a large-screen information display used in representative studies of a system hereof.

FIG. 3B illustrates segments of the large screen information display system of FIG. 3A displayed upon a local display of a tablet computer display system.

FIG. 3C illustrates segments of the large screen information display system of FIG. 3A displayed upon a local display of a holographic or mixed reality display of a mixed reality headset.

FIG. 4 illustrates an information display system including four QR code markers thereof which may be used to define the display bounds using a local display system hereof.

FIG. 5 illustrates a photograph of a hand menu in an embodiment of a holographic or mixed reality display hereof.

### DETAILED DESCRIPTION

It will be readily understood that the components of the embodiments, as generally described and illustrated in the figures herein, may be arranged and designed in a wide variety of different configurations in addition to the described representative embodiments. Thus, the following more detailed description of the representative embodiments, as illustrated in the figures, is not intended to limit the scope of the embodiments, as claimed, but is merely illustrative of representative embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As used herein and in the appended claims, the singular forms “a,” “an,” and “the” include plural references unless the context clearly dictates otherwise. Thus, for example, reference to “a segment” includes a plurality of such segments and equivalents thereof known to those skilled in the art, and so forth, and reference to “the segment” is a reference to one or more such segments and equivalents thereof known to those skilled in the art, and so forth. Recitation of ranges of values herein are merely intended to serve as a shorthand method of referring individually to each separate value falling within the range. Unless otherwise indicated herein, each separate value, as well as intermediate ranges, are incorporated into the specification as if individually recited herein. All methods described herein can be performed in any suitable order unless otherwise indicated herein or otherwise clearly contraindicated by the text.

As used herein, the term “segment” refers to a portion of an information display that is less than the entirety of the display area.

The terms “electronic circuitry,” “circuitry” or “circuit,” as used herein include, but is not limited to, hardware, firmware, software, or combinations of each to perform a function(s) or an action(s). For example, based on a desired feature or need. a circuit may include a software-controlled microprocessor, discrete logic such as an application specific integrated circuit (ASIC), or other programmed logic device. A circuit may also be fully embodied as software. As used herein, “circuit” is considered synonymous with “logic.” The term “logic,” as used herein includes, but is not limited to, hardware, firmware, software, or combinations of each to perform a function(s) or an action(s), or to cause a function or action from another component. For example, based on a desired application or need, logic may include a software-controlled microprocessor, discrete logic such as an application specific integrated circuit (ASIC), or other programmed logic device. Logic may also be fully embodied as software.

The term “processor,” as used herein includes, but is not limited to, one or more of virtually any number of processor systems or stand-alone processors, such as microprocessors, microcontrollers, central processing units (CPUs), and digital signal processors (DSPs), in any combination. The processor may be associated with various other circuits that support operation of the processor, such as random-access memory (RAM), read-only memory (ROM), programmable read-only memory (PROM), erasable programmable read only memory (EPROM), clocks, decoders, memory controllers, or interrupt controllers, etc. These support circuits may be internal or external to the processor or its associated electronic packaging. The support circuits are in operative communication with the processor. The support circuits are not necessarily shown separate from the processor in block diagrams or other drawings.

The term “memory system” refers to a collection of electronic components that store data and instructions. In computerized systems, a processor system can quickly access information stored in a memory system. Memory allows storage and retrieval of information and may, for example, include primary memory and secondary memory. Primary memory includes, for example, RAM, cache memory, etc. Secondary memory includes, for example, hard drives, hard disk drives etc.

The term “controller,” as used herein includes, but is not limited to, any circuit or device that coordinates and controls the operation of one or more input and/or output devices. A controller may, for example, include a device having one or more processors, microprocessors, or central processing units capable of being programmed to perform functions.

The term “software,” as used herein includes, but is not limited to, one or more computer readable or executable instructions that cause a computer or other electronic device to perform functions, actions, or behave in a desired manner. The instructions may be embodied in various forms such as routines, algorithms, modules, or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, or the desires of a designer/programmer or the like.

As used herein, the term “server” refers generally to a computer software program or computer device that provides a service to another computer program and to the user of that program (which is referred to as a “client”).

As used herein, the term “approximately” when used in connection with a value means within 5%, within 2%, or within 1% of the value unless otherwise indicated herein or otherwise clearly contraindicated by the text. As used herein the term “and/or” means one of or both of an entity. Thus, A and/or B means A or B, or both A and B.

In a number of embodiments, the devices, systems, and methods hereof improve the utility of display information for individuals performing a task. In that regard, one or more segments of display information (which is/are segmented from one or more information display systems in an environment or otherwise accessible to a user, for example, via a network) is/are displayed locally to a user performing a task via the devices, systems, and methods hereof. An interface may be provided via which the user may select at least one segment of a screen display from at least one of one or more information display systems. The selected segment(s) may, for example, be altered by the user over time. The segments may be displayed to the user via a display of a display system positioned locally to the user. Such a local display system or local display may, for example, be a display (or displays) of a personal computer, of a portable system, such as a display of a personal communication devices, or a display of a mixed reality headset. The user may control the position and/or size of each segment on the local display. For example, in the case of a mixed reality headset, the user may position the segment(s) at a desired position (and at a desired size) relative to the task as viewed through a see-through display (for example, around the body of a patient during surgery). Augmented reality (AR) and mixed reality (MR) are each technologies that overlay digital elements on the real world. MR further allows the physical and digital elements to interact with each other. In general, as used herein, the terms “local display systems” or “local display” refer to a display system in the vicinity of the user and upon which the user can control or select the information displayed.

As used herein, the term “personal communications device” refers to, for example, a portable or mobile device which includes a communication system, a processor system, a user interface system (for example, a visual feedback system including a touchscreen or other display, an auditory feedback system, and a tactile feedback system, a user input system etc.), a memory system in communication with the processor system, and an operating system stored on the memory system and capable of running general-purpose applications. Examples of personal communications devices include, but are not limited to, smartphones, tablet computers and custom devices. As used herein, the term “tablet computer” or tablet, refers to a mobile computer with a communication system, a processor system, at least one user interface as described above (typically including a touchscreen display), and an operating system capable of running general-purpose applications in a single unit. As used herein, the term “smartphone” refers to a cellular telephone including a processor system, at least one user interface as described above (typically including a touchscreen display), and an operating system capable of running general-purpose applications. Such communication devices are typically powered by rechargeable batteries and are housed as a single, mobile unit. Moreover, in a number of embodiments, such communications devices are able to accept input directly into a touchscreen (as opposed to requiring a keyboard and/or a mouse) or via voice commands. Personal communications devices for use herein typically provide for either wired and/or wireless communication as known in the computer arts.

As compared to other forms of local displays, in the case of MR headset, users may, for example, have increased agency to place content in locations that can further reduce or minimize split attention and improve overall information ergonomics (for example, in a manner to decrease cognitive load). The affordances provided by holographic or mixed reality displays in MR are very desirable in facilitating information-mediated physical tasks. A number of representative embodiments of devices, systems, and methods hereof are thus discussed in connection with use of a MR headset. However, one skilled in the art will appreciate that the present devices, systems, and methods may be used in connection with other display systems local to a user performing a task such as a display of a personal computer, a display of a tablet computer, or a display of another personal communication device.

Use of the term “holographic display” is becoming less common in the spatial computer literature. As used herein, the term “holographic display” refers to a display in which virtual or digital information or objects are able to be situated or overlayed upon the physical or real world (that is, displayed upon the physical or real world). Such displays are also sometimes referred to herein as “mixed reality displays.”

Complex information ecosystems (for example, “multi-display environments” or “multi-surface environments”) are common across many domains. Multi-display environments, sometime referred to as multi-surface environments, have been described as environments in which interactions span multiple input and output devices and can, for example, be performed by several users simultaneously. Garcia-Sanjuan, F., et al., Toward a General Conceptualization of Multi-Display Environments, Frontiers in ICT Volume 3—2016 (2016); and Gjerlufsen, T., et al., Shared substance: developing flexible multi-surface applications. In Proceedings of the SIGCHI Conference on Human Factors in Computing Systems (Vancouver, BC, Canada) (CHI '11), Association for Computing Machinery, New York, NY, USA, 3383-3392 (2011). For example, in processing plants, controllers view and understand large amounts of visual information and react quickly in the case of an emergency. In command and control centers, first responders consult real-time incident data and respond in a timely manner. Financial analysts and traders, are required to view tremendous amounts of financial information from multiple sources. In operating rooms, surgeons pay close attention to a variety of information sources, including monitors and alarms, while operating to, for example, ensure the patient remains stable, facilitate surgical procedures, enhance surgical outcome, etc.

During an operation, a surgeon might for example, consult information from a display showing endoscopic footage or a display of patient vital signs, while simultaneously manipulating the patient's anatomy. In the current operating room setup, where information is tethered to displays of various information display systems, surgeons are, for example, forced to split their attention between the operative field (that is, the patient's anatomy), the endoscopic display footage and/or other displays.

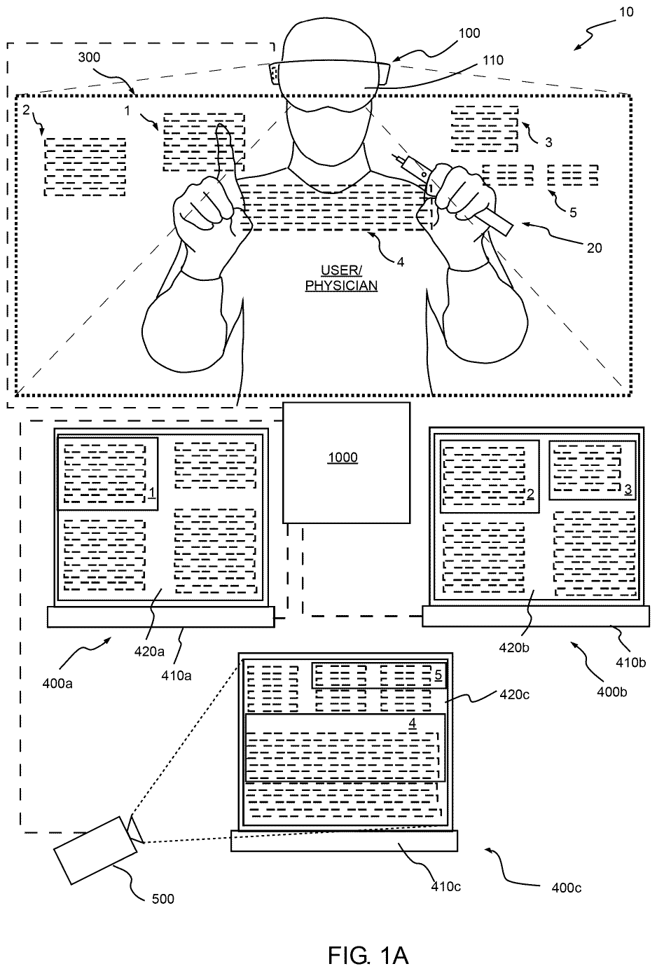

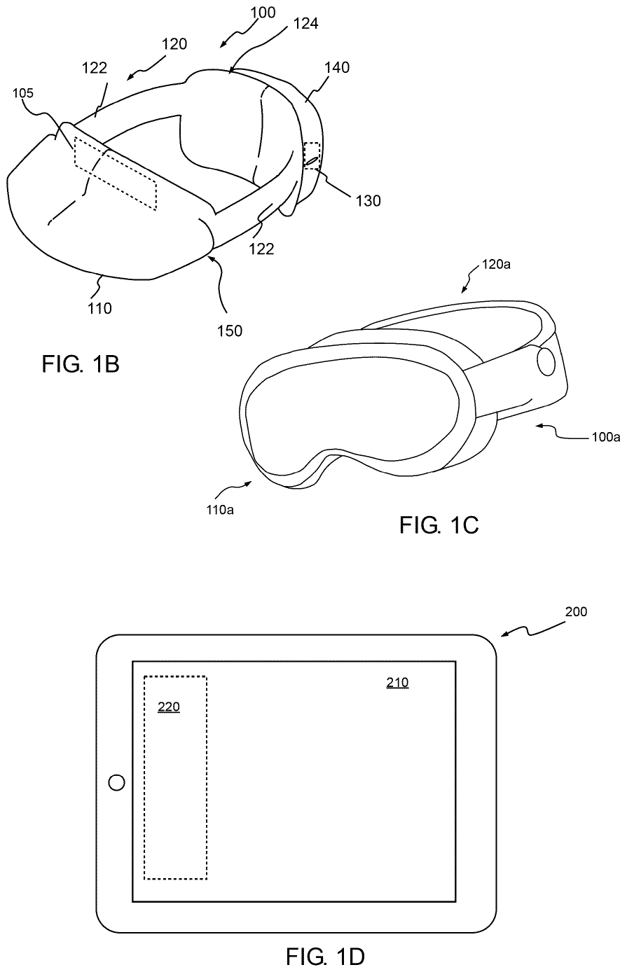

In FIG. 1A, a user (for example, a physician/surgeon) is illustrated wearing a mixed reality (MR) headset 100 and holding surgical device 20. FIG. 1B illustrates schematically an embodiment of headset 100, which includes a visor/display 110, which may, for example, be a rotatable (or pivotable) and see-through display. A band or arm system 120 including arms or bands 122, which connect to a rear pad 124, may be used to retain augmented reality headset 100 on the head of a user. An upper strap (not shown) may also be used to cooperate with the top of a user's head. A communication system 130 may, for example, be provided in a rear component housing 140. Communication system 130 may, for example, provide for wireless communication (for example, via BLUETOOTH, a wireless communication protocol administered by Bluetooth SIG, Inc. of Kirland, Washington, Wi-Fi, etc.) and wired communication (for example, via a universal serial bus or USB port, via ethernet, etc.). Headset system electronic circuitry 105 (electronics/components; illustrated schematically in FIG. 1B) may, for example, be distributed between a front component housing/support 150 and rear component housing 140. As known in the art, an external power source (not illustrated) may be used to charge/power headset 100 (which typically includes a rechargeable battery system) through its native power input. Among other components electronic circuitry 105 may, for example, include a processing system and a memory system in communication with the processor system. Software executable by the processor system is stored in the memory system. FIG. 1C illustrates schematically another embodiment of a headset 100a including a mixed reality display 110a (for example, a pass-through display) and a support system 120a to retain headset 100a in connection with a user's head.

FIG. 1D illustrates an embodiment of a tablet computer 200 for use herein. As known in the art, tablet computer includes a display 210 and electronic circuitry (not illustrated) including a processor system, a memory system in communication with the processor system, and a communication system (not shown) for wired and/or wireless communication in communication with the processor system.

Referring again to FIG. 1A, MR headset 100 is configured to construct a virtual user interface that can be displayed to the user intraoperatively via, for example, a holographic or mixed reality interface/display 300. During surgery, the physician may interact with the virtual user display 300 via several modalities, including but not limited to, virtual touch or gesture (that is, virtually pressing or selecting virtual buttons or menu items), eye gaze, and/or voice commands. In FIG. 1A, only the display generated by MR headset 100 is illustrated and not what is visible by the surgeon via the see-through display thereof. Adaptations of MR headsets suitable for use herein are described, for example, in PCT International Publication No. WO 2024/077077, the disclosure of which is incorporated herein by reference.

In the representative surgical environment of FIG. 1A, three informational display systems 400a, 400b, and 400c are illustrated. Such informational display systems may, for example, be positioned at various locations within the surgical environment/operating room or external thereto. Other informational displays which may be segmented for view by a user of devices, systems, and methods hereof may be remote from the user and not within the view of the user. An information display to be segmented may be available via a wide area network (for example, the internet). In a representative example, of a remotely available display, a surgeon may want to view a 3D display of a portion of a patient's anatomy that is not available on any screen in the surgical environment/operating room (for example, during vascular reconstruction). Such a surgeon may, for example, select a segment of a displayable screen for data in a central repository of patient data for display on user display 300. A surgeon may also wish to view a portion/segment of an instrument control device (for example, a controller for an electrocautery device) including the display thereof and/or setting controls thereof to confirm appropriate setting and/or the determined desired changes in such setting. The instrument control device may be positioned external to the sterile field or external to the surgical environment/operating room. Use of MR headsets in control of devices outside of a sterile filed is, for example, discussed in PCT International Patent Application No. PCT/US2025/052027, the disclosure of which is incorporated herein by reference. A camera may, for example, be used to stream video of such an instrument including the display and/or setting controls. An engineer in control of a process/system may, for example, wish to have locally displayed an image or text relating to a particular device or system that may not be available from an information display system in the vicinity of the engineer but is available from a central depository of data or via the internet. In general, any source of an informational display may be segmented for local display by a user hereof.

Each of representative information display system 400a, 400b, 400c (for example, monitor systems) may, for example, include an associated computerized system 410a, 410b, 410c which generates information to be visually represented upon a display 420a, 420b, 420c in communication with computerized system 410a, 410b, 410c. As described above, under current practice (with or without use of MR headsets during surgery) surgeons are, forced to split their attention between the operative field (that is, the patient's anatomy) and one or more displays such those of display systems 400a, 400b, 400c.

In system 10 hereof, the user, in this case a surgeon/physician, may select one or more segments (or display segments) such as segments 1, 2, 3, 4, and 5 of displays 420a, 420b, 420c for display on holographic or mixed reality display 300 at user defined positions thereof as illustrated in FIG. 1A. One or more such segments may be selected from a given display. The user may thereby pay close attention to a variety user-designated information segments from one or more display sources, including monitors and alarms, while operating to ensure the patient remains stable.

In a number of embodiments hereof, segments 1, 2, 3, 4, and 5, are displayed via holographic or mixed reality display 300 via streaming (in which, video data thereof is transmitted in sequential packets of data). The application can, for example, either stream output from a camera in connection with an information display system (see camera 500 in operative connection with display system 400c in FIG. 1A) or a capture video data from an information display system (see display systems 400a and 400b of FIG. 1A).

In a number of embodiments hereof, a streaming interface system or streaming interface 1000 (see FIG. 1A) is used. In general, a streaming interface includes one or more software and/or hardware components that facilitate or provide for transmission and reception of real-time data including, for example, audio and/or video data.

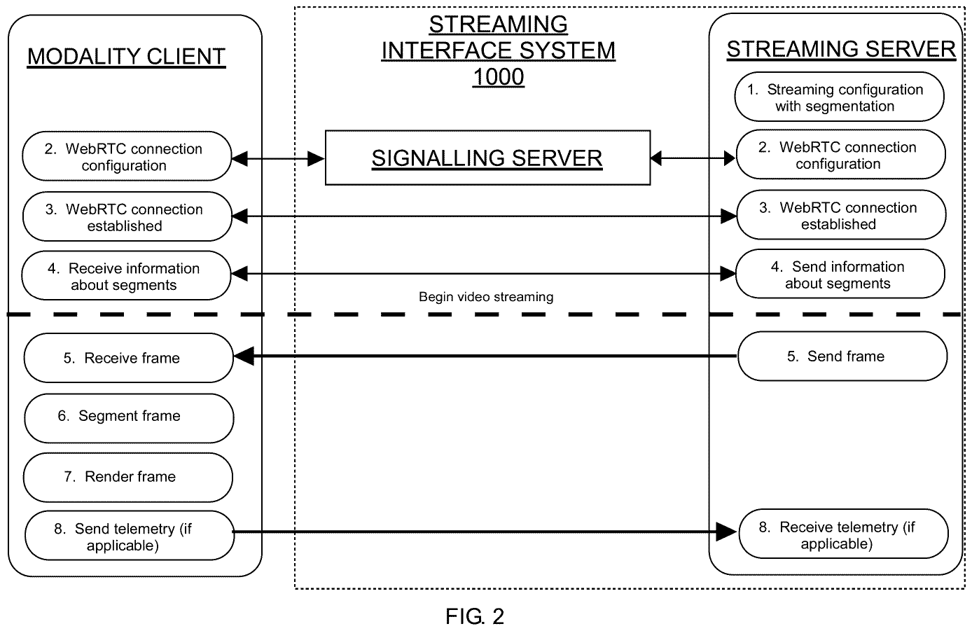

A streaming interface hereof may, for example, include a streaming server application or streaming server. In representative studied embodiments, the streaming server was a web-based application developed in HTML, CSS, and JavaScript. The streaming server application may, for example, stream a camera (such as camera 500) connected to an information display system (for example, a computer system) or a capture of a computer systems screen, as seen in a number of studies hereof. In representative studied embodiments, the underlying streaming technology for the streaming server was WebRTC (open source software for real-time communication via the web; see FIG. 2). While a number of relatively low-latency protocols exist and are suitable for use herein, WebRTC was chosen for use in a number of representative studies hereof because of its comparatively low latency and compatibility with the selected tablet, with the selected mixed reality modalities of the studies, and with the WebXR standard, which is further discussed below. Other suitable protocols include, for example, the NDI protocol (available from Vizrt of Bergen, Norway), which uses standard IP networking to discover and transmit audio and/or video data streams between devices, and which may be used in a peer-to-peer manner for direct device-to-device communication within a local network. NDI may further be extended for use over wide-area networks. Another example, of a protocol suitable for use herein is the JPEG XS protocol (available for licensing via the JPEG XS Patent Portfolio License). Various codecs for compression and decompression of video data such as H.264 (open source versions of which are available via GitHub) and VP9 (an open-source codec) may be used herein.

WebRTC requires a signaling server (see FIG. 2) that is shared between peers to exchange information about available communication channels (known as ICE candidates) and a connection string. In general, a signaling server manages connection between peers. In the studied systems, the signaling server was implemented in NodeJS (an open-source, cross-platform JavaScript runtime environment and library for running web applications outside the client's browser) with the Socket. IO communication protocol (which allows bi-directional communication between client and server).

When starting a new streaming session, the user may first choose an input source for the stream (for example, either webcam or screen capture of a screen display of one or more information display systems) and choose a streaming resolution. In a number of studies hereof, the screen was captured at a default resolution of 1280 pixels by 720 pixels. The user can then choose to define one or more segments a particular informational display screen by, for example, drawing boxes (or other shapes) around a displayed preview, by selecting one or more predefined segment options, via gaze detection (as known in the computer arts), or by selecting a default segmentation option (for example, 4 equally-sized segments or 6 equally-sized segments). Predefined segment options or default segment options may, for example, be defined or revised by a user for repeated use. Predefined segments may be numbered or otherwise designated/described (for example, by color, a short description (such as “parietal view”), etc.) for quick recall (for example, via selection from a menu thereof or via voice command) and display.

The interface for selection, identifying, positioning and/or sizing of segments may be multimodal. For example, not all users are fully comfortable with an MR interface. In a number of embodiments, one or more modalities other than MR (such as table computer 200) may be used in the interface for selection, identifying, positioning and/or sizing of segments.

Video may be streamed to clients in a single stream. In a number of embodiments, segmentation is performed on the client with bounds provided by the streaming server. After the display is configured and segmented, the user may start the streaming server to begin streaming.

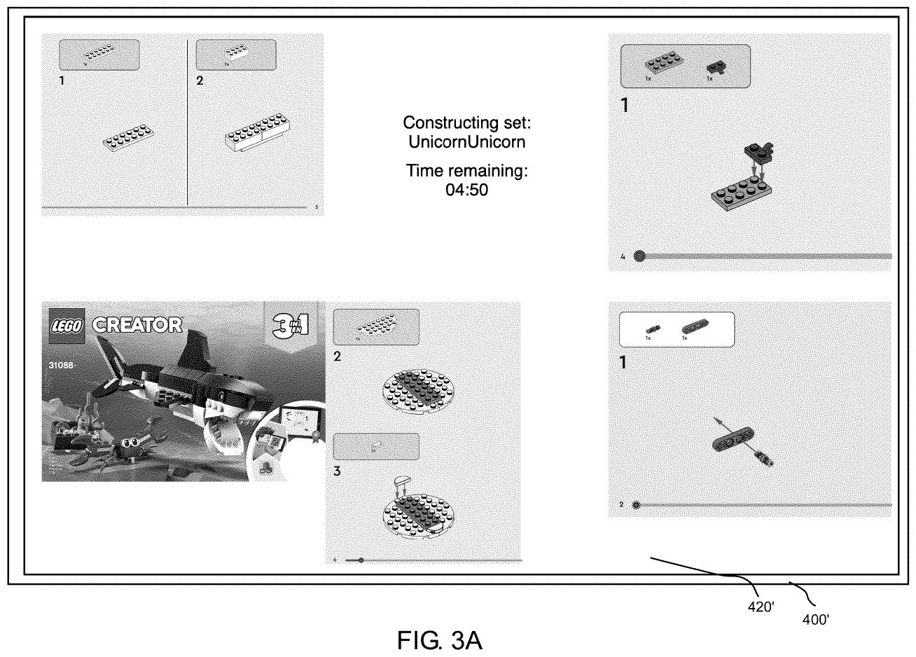

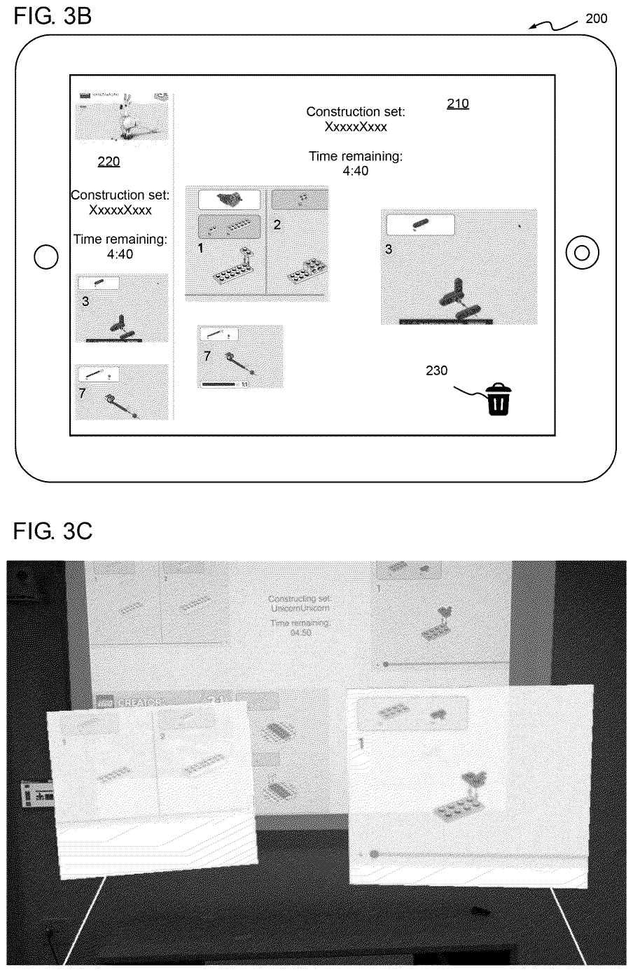

FIGS. 3A through 3C illustrates a representative study of a segmenting system hereof. In that study, a single, large information display system 400′ including a display 420′ was used (FIG. 3A). The display was a 98″ NEC C981Q. The streaming server was hosted on an Apple MacBook Pro (MacOS version 14.0). As described above, the MR streaming client was run on a MICROSOFT® HOLOLENS® 2 AR headsets (OS version 22621.1272), available from Microsoft, Corporation of Redmond, WA, in the Edge Browser (version 121.0.2277.128). The tablet streaming client was run on an Apple 9th Generation iPad (iPadOS version 17.3.1) in the Safari browser. All devices were connected via a local wireless network.

The representative tasks studied in the embodiment of FIGS. 3A through 3C in evaluating devices, systems, and method hereof involved the construction of construction formations using LEGO® construction sets available from The Lego Group of Billund, Denmark. In those studies, an instructions application for the tasks, was implemented. The instruction application was written in HTML, CSS, and JavaScript and designed to be run in a web browser. The application presented 6 information items in a 2×3 grid. This conformation was chosen to mimic a variety of shared display layouts common in complex information ecosystems. To support the experimental design, the information items represent instruction sequences for each of two Lego sets. The instruction application, by default, operated as the large display modality for the experimental design. At launch, the instructions were preloaded, and a member of the research team selected the two Lego sets that would be constructed for the experimental task. Of the six information components, five were instruction sequences. The other information component showed the current Lego set and the time remaining for the experimental task. Three sequences were of random Lego sets not related to the participant's task. Those sequences advanced automatically at a randomized rate of one instruction figure every 1-10 seconds. Two sequences were of the Lego sets assigned to the participant for construction. All segment positions were randomized to one of the six positions.

To start the task, the experimenter pressed the space bar to show the first instruction and initiate the automatic advancement of the random sets. The experimenter advanced the currently active Lego set to the next instruction by pressing the space bar. During the experimental task, participants switched between construction of the two assigned Lego sets at a random time interval between 15-60 seconds. The signal to switch was given as an auditory chime and reflected in the task status segment. After time expired, the system displays the number of instructions that were completed for each set.

HOLOLENS 2 MR headset 100 (FIG. 1B) used in the studies of FIGS. 3A through 3C includes a translucent or see-through display 110. Translucent display 110 of MR headsets 100 may allow users to view their task in a manner more representative of their unobscured vision. Other MR headsets such as the MAGIC LEAP® 2 AR headset available from Magic Leap of Plantation, Florida may be used in systems hereof. This viewing mode is in contrast to passthrough MR devices, which capture the outside world with cameras and reproject it within the headset. The HOLOLENS 2 is considered to be a state-of-the-art device and is widely used in the literature. Augmented/mixed reality headsets suitable for use herein also include pass-through headsets. In pass-through headsets, the headset includes one or more external cameras or image sensors to provide an image or live video feed of one's physical surroundings. Virtual objects/digital information is overlain upon the image/video feed. A representative example of a pass-through headset suitable or adaptable for use herein is the APPLE VISION PRO headset available from Apple, Inc. of Cupertino, California. In the case of pass-through displays, image processing and graphics rendering are used to blend and display physical and generated reality in real time. Augmented reality (AR) and mixed reality (MR) are each technologies that overlay virtual or digital elements on the real world. MR further allows the physical and digital elements to interact with each other.

In the studied embodiments, the MR streaming client was built with the WebXR standard (a device API that provides support for accessing augmented reality and virtual reality devices) using the THREE.js JavaScript library. A web-based format for the application was chosen so the system could be used on multiple MR headsets without additional configuration and for better WebRTC support. While other commonly used MR development platforms like Unity do have support for WebRTC, WebXR required the least amount of configuration to connect to the streaming server.

In the studied embodiments, once initialized, MR headset 100 was calibrated by outlining the bounds of a particular information display to be segmented (large display 420′ in the studies of FIG. 3A). This may, for example, be accomplished by the user pinching their fingers at the four corners of the display. For the user gestures described in connection with the studies hereof, other gesture or voice commands may be used. Following calibration, the system connects to the signaling server and exchanges information with the streaming server to open a WebRTC connection (see, for example, FIG. 2). After establishing the WebRTC connection, the MR headset client may display a faint hologram over information display 420′ as a guide, segmented based on the bounds provided by the streaming server (see FIG. 3C). The user of MR headset 100 could choose which segments of the information display to virtualize by, for example, pointing their hand at a segment on the faint display guide hologram, pinching their fingers, and pulling away from the screen. This procedure creates a holographic or mixed reality clone of the selected display segment. The user can, for example, move that segment by pinching and dragging with one hand or scaled/rotated by pinching and dragging with two hands. In a number of studied embodiments, only one clone of each display segment could be created at one time. If the user attempted to create a new version of an already cloned segment, the previously created clone was destroyed. Users may, for example, delete virtual segment by placing it near its original position on the “ghost display.” Virtual segments were redrawn from the WebRTC video stream at 60 frames per second in a number of studies, as dictated by the THREE.js library rendering pipeline.

A tablet system (see FIGS. 1D and 3B) may be constructed similarly to the MR system described above. In that regard, the same signaling server, streaming server application, may be used for both systems. However, the tablet system may use a separate streaming client designed specifically for tablet computer or tablet 200. The tablet client in a number of studies was also packaged in a web application, allowing for cross-platform deployment. Upon initialization, the client connects to the signaling server to exchange WebRTC connection information with the streaming server (see FIG. 2). Once the WebRTC connection has been configured, in the studied embodiment, the tablet client builds a sidebar interface 220 on display 210 thereof (illustrated on the left side of display 210 in FIG. 3B) using the segmentation bounds provided by the streaming server. In a number of embodiments, when the user taps one of the preview segments presented on the left sidebar, a clone of the segment is created and placed in the “playspace” (that is, the larger area shown on the middle of tablet display 210). Once segment clones have been created in the playspace, the user may, for example, manipulate them by dragging with one finger or scaling using pinching gestures with two fingers. A user may have multiple different segments in the playspace at one time. However, similar to the MR client, multiple clones of the same segment were not allowed at one time in the studied embodiments. If the user attempted to clone a segment that was already extant in the playspace, the older clone was destroyed. When a user wanted to remove a segment from the playspace, they could position the segment near the trash can object in the bottom right corner, which will cause it to be deleted. All segments, both on the sidebar and in the playspace, were redrawn from the WebRTC video stream at 30 frames per second. If the user were actively interacting with a virtual segment during a frame, the interaction was logged and transmitted to the streaming server, where it could be downloaded by the user in JSON format.

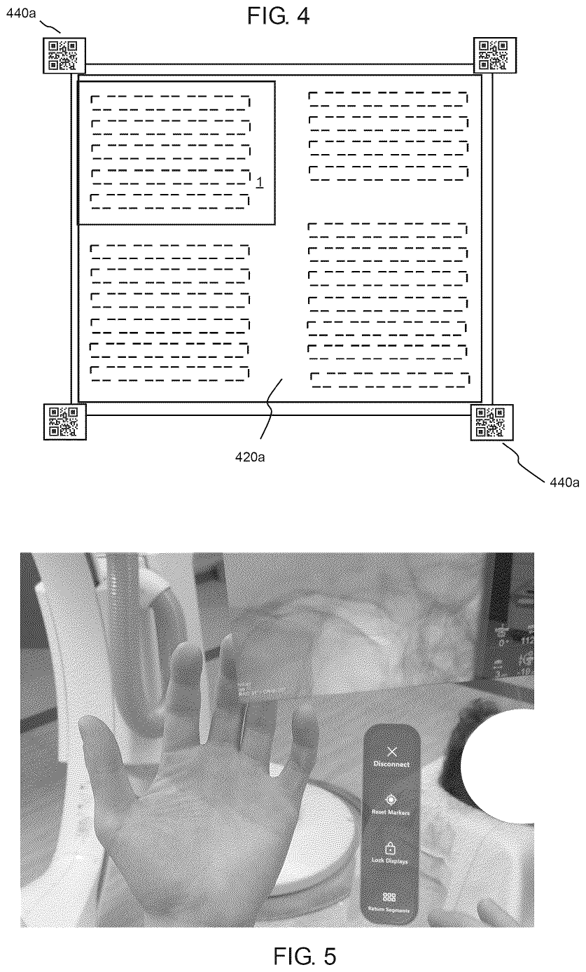

In other embodiments hereof, a direct connection between a local display system hereof (for example, MR headset 100) and a streamlining interface (which may, for example, include a streaming server) may be used. In a number of embodiments, the streaming interface or streaming server is a “computer application.” As used herein, the term “computer application” refers to a software program installed directly on a computer. A “web-based application,” on the other hand, is a program accessed through a web browser, meaning it runs on a remote server and is accessed via the web browser. In a representative embodiment, before the connection is initiated, the user may configure the streaming interface (for example, including a streaming server) by first selecting a video input device. The video input device may, for example, be either a screen capture or a camera/webcam device as described above. The user may then configuring the bounds of segmentation. In a number of embodiments, on the client side, and before connecting, the user can look at a set of four display markers (QR codes) 440a as illustrated in FIG. 4 while donning MR headset 100 to situate the segments on physical display 420a. Any type of optical marker/tracking system as known in the art may be used (for example, passive IR tracking, AprilTags (an open source visual fiducial system developed by the April Robotics Laboratory of the University of Michigan and accessible through the AprilRobotics GitHub repositories), ArUco markers (open source AR markers developed by the University of Cordoba and available via programming libraries such a OpenCV or through online generation tools), etc.). Three display markers 440a may be used to adequately define bounds, but four were used in studies hereof to increase accuracy. The use of markers 440a is an optional feature set that as added for a specific use case. After configuring the segmentation bounds on the streaming interface, the user may select a “Start Stream” option, which may, for example, display another “connection” QR code that encodes connection and segmentation data. After the connection QR code is displayed, MR headset 100 (or other local display technology) detects the QR code and connects to the streaming server. Segments (such as segment 1) are then freely placeable in the virtual environment (or other display technology, if applicable). In a number of embodiments of the streaming application, there is a hand menu available to users to disconnect from the streaming interface, reset markers (used for locating the physical display), lock the segments' positions, and reset the positions of the segments. A photo of the hand menu in provided in FIG. 5.

When the QR code is displayed by the streaming server, it simultaneously creates a TCP server and waits for incoming connections. When it receives a TCP connection, it begins streaming the entire video capture with MJPEG by (1) capturing the frame, (2) encoding the frame in JPEG format at a predefined quality (“quality” as defined in the JPEG specification, effectively describing “the required bit count per one pixel of the compressed image” from 1-100), and (3) sending over the TCP connection. Frames are received one-by-one on the client from the TCP connection, decoded to pixel data, and displayed as quickly as possible.

Representative studies described above enabled investigation of the effects of different display modalities (MR headsets 100, tablets 200, and large information displays 400′) on various variables such as user preference and task performance within complex information ecosystems. In choosing a display modality or modalities and system architecture, user preference, interactivity, and the nature of the task are first-order considerations in the architecture of complex information ecosystems.

A tablet modality inherently requires tactile interaction and has limited screen space compared to the other two studied modalities. Thus, study participants often adjusted the layout to emphasize the segments that were the most relevant for their current task. Time spent on interaction (for example, selections, repositions, and resizes) had a positive relationship with performance for the tablet modality. In contrast, an MR modality does not require substantial manipulation from participants since the task was spatially static and hologram sizes were not physically constrained. Once the holographic or mixed reality segments were placed, participants did not feel a need to readjust them. The large display modality, by its nature, does not support interaction.

The unique limitations and requirements of certain information-rich, display-rich environments such as the operating room present an opportunity for local display systems incorporating devices, systems, and methods for segmentation. MR modalities may provide unique advantages. Using devices, systems, and methods hereof, a surgeon can, for example, choose segments of one or more shared monitor as described above to view in more detail during a particular surgical step. Likewise, a first responder can, for example, enlarge a map of an area experiencing increased activity during a crisis, or a factory worker can inspect a malfunctioning machine.

Not all information provided on one or more information display systems may be relevant to task at hand or to one or more stages (over time) of a task at hand. Further, the location/position of information presented on a single information display system or distributed over more than one information display system may not be useful for a task or a particular stage of the task. The technology hereof provides a significant improvement in the art by allowing a user of a local display system to choose segments or portions of displays of one or more information display systems for local display, while enabling control of the selection, size, position, etc. of the segments on the local display. MR headsets including see-through displays provide particular advantages in control of size, positions, etc. of selected segments while concurrently or simultaneously viewing the task at hand.

In a number of embodiments, the devices, systems, and methods hereof enable the capture, segmentation, and subdivision of display information into world-anchored virtual representations. Users may segment a captured display along user-defined or predefined boundaries, displaying the resulting subdivisions or segments as interactive tiles represented as virtual world-anchored objects or shown on a screen of a device such as a tablet.

The foregoing description and accompanying drawings set forth a number of representative embodiments at the present time. Various modifications, additions and alternative designs will, of course, become apparent to those skilled in the art in light of the foregoing teachings without departing from the scope hereof, which is indicated by the following claims rather than by the foregoing description. All changes and variations that fall within the meaning and range of equivalency of the claims are to be embraced within their scope.

What is claimed is:

1. A method of providing information to a user via a local display system, the local display system including a local display, comprising:
providing an interface via which the user may select at least one segment of a screen display from at least one of one or more information display systems for display on the local display, and
displaying the at least one segment on the local display.

2. The method of claim 1 wherein the local display system comprises the local display and electronic circuitry in communicative connection with the local display, the electronic circuitry including a processor system and a memory system in communication with the processor system, the method further comprising:
providing software stored in the memory system of the local display system, the software being executable by the processor system to provide the interface.

3. The method claim 2 further comprising providing a streaming interface, the streaming interface being in communicative connection with the local display system and with the one or more information display systems, the streaming interface being configured to stream screen display data of the one or more information display systems to the local display system, wherein the software is further executable by the processor system to segment the screen display data to display the at least one segment on the local display.

4. The method of claim 1 wherein the local display system is selected from a mixed reality headset and a personal communication device.

5. The method of claim 4 wherein the local display system is a mixed reality headset.

6. The method of claim 3 wherein the streaming interface comprises a streaming server.

7. The method of claim 3 wherein the streaming interface comprises at least one of a computer application and a hardware device.

8. The method of claim 6 wherein the streaming server comprises a web-based software application and the software is a web-based client software application.

9. The method of claim 6 wherein the streaming interface further comprises a signaling server which is configured to manage connections between the local display system and the streaming server.

10. The method of claim 3 wherein the streaming interface is configured to stream screen display data obtained from at least one of (i) a camera in optical connection with a display of one of the one or more information display systems and (ii) a capture of the screen display data of the one or more information display systems.

11. The method of claim 1 wherein the user is provided control of at least one of the size and position of the at least one segment on the local display.

12. A system for providing information to a user, comprising:
a local display system, the local display system including a local display, and
an interface via which the user may select at least one segment of a screen display from at least one of one or more information display systems for display on the local display.

13. The system of claim 12 wherein the local display system comprises electronic circuitry in communicative connection with the local display, the electronic circuitry comprising a processor system and a memory system in communication with the processor system, the memory system having software stored therein which is executable by the processor system to (i) provide the interface and (ii) display the at least one segment on the local display.

14. The system of claim 13 further comprising a streaming interface, the streaming interface being in communicative connection with the local display system and with the one or more information display systems, the streaming interface being configured to stream screen display data of the one or more information display systems to the local display system, wherein the software is further executable by the processor system to segment the screen display data to display the at least one segment on the local display.

15. The system of claim 12 wherein the local display system is selected from a mixed reality headset and a personal communication device.

16. The system of claim 15 wherein the local display system is a mixed reality headset.

17. The system of claim 14 wherein the streaming interface comprises a streaming server.

18. The system of claim 14 wherein the streaming interface comprises at least one of a computer application and a hardware device.

19. The system of claim 17 wherein the streaming server comprises a web-based software application and the software is a web-based client software application.

20. The system of claim 17 wherein the streaming interface further comprises a signaling server which is configured to manage connections between the local display system and the streaming server.

21. The system of claim 14 wherein the streaming interface is configured to stream screen display data obtained from at least one of (i) a camera in optical connection with a display of one of the one or more information display systems and (ii) a capture of the screen display data of the one or more information display systems.

22. The system of claim 12 wherein the user is provided control of at least one of the size and position of the at least one segment on the local display.

23. A local display system for providing information to a user, comprising: a local display and electronic circuitry in communicative connection with the local display, the electronic circuitry comprising a processor system and a memory system in communication with the processor system, the memory system having software stored therein which is executable by the processor system to provide an interface via which the user may select at least one segment of a screen display from at least one of one or more information display systems for display on the local display and to display the at least one segment on the local display.
